(19) United States
(12) Patent Application Publication
(10) Pub. No.: US 2023/0106298 A1
(43) Pub. Date: Apr. 6, 2023

(54) SYSTEM AND METHOD FOR ORGANIZING, RETRIEVING, AND ACCESSING INFORMATION BASED ON DATABASE STRUCTURES IN REAL TIME BASED ON CONCURRENT CONVERSATIONS

(71) Applicant: Cymantix, Inc., Cary, NC (US)

(72) Inventors: Javed Mostafa, Cary, NC (US); Weimao Ke, Chalfont, PA (US)

(21) Appl. No.: 17/938,566

(22) Filed: Oct. 6, 2022

Related U.S. Application Data
(60) Provisional application No. 63/252,950, filed on Oct. 6, 2021.

(51) Int. Cl. H04N 7/15; G10L 15/26; G06F 16/45; G06F 16/41

(52) U.S. Cl. CPC H04N 7/155; G10L 15/26; G06F 16/45; G06F 16/41

(57) ABSTRACT

A system and method of organizing, retrieving, and accessing information comprising the steps: providing an electronic platform configured to allow one or more individuals to have a conversation; creating a contemporaneous record of said conversation on said electronic platform; continuously generating suggestions and information to one or more users based on said conversation; wherein said suggestions and information are determined in part by said electronic platform determining an appropriate minimum dictionary language library; displaying said suggestions and information to said one or more users.

### CROSS-REFERENCE TO RELATED APPLICATIONS

This U.S. Non-Provisional Utility Patent Application claims the benefit of U.S. Provisional Patent Application No. 63/252,950, filed Oct. 6, 2021, titled “SYSTEM AND METHOD FOR ORGANIZING, RETRIEVING, AND ACCESSING INFORMATION BASED ON DATABASE STRUCTURES IN REAL TIME BASED ON CONCURRENT CONVERSATIONS,” with the first named inventor Javed Mostafa. The contents of which are hereby expressly incorporated herein as though set forth in their entirety, and to which priority is claimed.

### FIELD OF USE

The present disclosure is related to systems and methods for monitoring conversations and contemporaneously providing helpful information and feedback on a continuous basis.

### BACKGROUND

Computers have revolutionized a number of industries, allowing for automation on a wide scale. Additionally, in the modern age of video conferencing and other electronically enhanced conversations, a significant amounts of data is lost the instant that the conversation passes. One method of memorializing this sort of data is by recording the conversation by video, audio, or written recordings. However, recording data via these methods with nothing more does not add any new information that may be useful to the individuals, it merely allows individuals to rediscover what was said at a later time. The use of these recordings is extremely limited, and it's usually not particularly helpful in the moment.

Additionally, merely memorializing conversations has the effect of creating massive stockpiles of data that can be so voluminous that it may be affectively impossible to actually use this data.

Accordingly, what is needed is a system and method for recording conversations and providing additional relevant information that may be helpful to the conversation in the moment.

### SUMMARY

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented hereinbelow. It is to be understood that both the following general description and the following detailed description are exemplary and explanatory only and are not restrictive.

In accordance with the embodiments disclosed herein, the present disclosure is directed to a system that creates an intelligent meeting assistant tool to help people organize, retrieve, and access information in a convenient, effective way. The current operating environment of virtual conferencing software enables transcription (e.g., speech-to-text), which may have value in certain scenarios. However, these transcripts are not logically organized or interactive in the way they are generated.

It is an object of the present disclosure to enable highly interactive and collaborative intelligent meeting management through the use of a Minimum Dictionary Language (MDL) and Continuous Search. In this paradigm, high quality meeting agendas, notes, action items, and various entities and resources discussed during meetings will be created without direct human transcription and instead be a product of human-machine collaboration through an ambient intelligence. While the meetings may preferably be virtual, the meetings may comprise any interaction between two or more individuals, even if the meeting is conducted in person or through some other proxy. In some embodiments, it may be possible that a single individual communicating aloud or via other mechanisms may also make use of the present disclosure.

One embodiment may be a method of organizing, retrieving, and accessing data comprising the steps of providing a video conferencing platform, providing a real time processing application, where the video conferencing platform is configured to allow one or more individuals to have a conversation, where the video conferencing platform comprises an authorization granting protocol, where the real time processing application comprises an authorization receiving protocol, generating a media feed by the video conferencing platform, prompting the one or more individuals to grant an authorization via the authorization granting protocol and authorization receiving protocol, and transmitting, electronically, the media feed to said real time processing application after the authorization is granted by the one or more individuals.

In another embodiment, the method of organizing, retrieving, and accessing data may further comprise the step of creating a contemporaneous record of the conversation by the real time processing application. In another embodiment, the method of organizing, retrieving, and accessing data may further comprise the step of receiving an audio component of the media feed and generating a text record of the audio component by a transcription application. The method of organizing, retrieving, and accessing data may further comprise the step of transmitting, electronically, to the real time processing application the text record. In another embodiment, the method of organizing, retrieving, and accessing data may further comprise the step of utilizing, by the real time processing application, a minimum dictionary language library to identify one or more key terms contained within the text record. In another embodiment, the method of organizing, retrieving, and accessing data may further comprise the step of searching one or more indices of institutional resources for the one or more key terms.

Another embodiment of the method of organizing, retrieving, and accessing data may further comprise the step of generating by the real time processing application one or more notifications based on said search of one or more indices of institutional resources. In another embodiment, the one or more key terms comprise entities, words, and/or phrases. In another embodiment, the generation of the one or more notifications is continuous based on the text record.

Another embodiment of the method of organizing, retrieving, and accessing data may further comprise the step of displaying the one or more notifications to the one or more individuals. In another embodiment, the one or more notifications comprise information. In another embodiment, the one or more notifications comprise information responsive to the text record. In another embodiment, the one or more notifications are configured to provide information relevant to the text record. In another embodiment, the one or more notifications are configured to allow the one or more individuals to review information to enhance a conversation between the one or more individuals.

In another embodiment of the method of organizing, retrieving, and accessing data, the media feed comprises audio and/or video. In another embodiment, the transcription application is a part of the real time processing application.

Another embodiment may be a method of organizing, retrieving, and accessing data comprising the steps of providing an electronic platform, where the electronic platform comprises a video conferencing platform and a real time processing application, where the video conferencing platform is configured to allow one or more individuals to have a conversation, generating a media feed by the video conferencing platform, where the media feed comprises audio, transmitting electronically the media feed to the real time processing application, creating a contemporaneous record of the conversation by the real time processing application, receiving an audio component of the media feed and generating a text record of the audio component by a transcription application, transmitting electronically to the real time processing application the text record. Where the transcription application is a part of the real time processing application, utilizing, by the real time processing application, a minimum dictionary language library to identify one or more key terms contained within the text record, where the one or more key terms comprise entities, words, and/or phrases, searching one or more indices of institutional resources for the one or more key terms, generating by the real time processing application one or more notifications based on the search of one or more indices of institutional resources, where the generation of the one or more notifications is continuous based on the text record, and displaying the one or more notifications to the one or more individuals.

Still other advantages, embodiments, and features of the subject disclosure will become readily apparent to those of ordinary skill in the art from the following description wherein there is shown and described a preferred embodiment of the present disclosure, simply by way of illustration of one of the best modes best suited to carry out the subject disclosure. As it will be realized, the present disclosure is capable of other different embodiments and its several details are capable of modifications in various obvious embodiments all without departing from, or limiting, the scope herein. Accordingly, the drawings and descriptions will be regarded as illustrative in nature and not as restrictive.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is a block diagram of one embodiment of a system for organizing, retrieving, and accessing information in real-time.

FIG. 2 is an illustration of a graphical user interface of a user reviewing information provided by one embodiment of a system for organizing, retrieving, and accessing information in real-time.

FIGS. 3-4 are flow diagrams showing various security and networking steps for one embodiment of the system for organizing, retrieving, and accessing information in real-time.

FIGS. 5A-B is a flow diagram showing one method of organizing, retrieving, and accessing data.

FIG. 6 is a flow diagram showing one method of organizing, retrieving, and accessing data.

### DETAILED DESCRIPTION OF THE ILLUSTRATIVE EMBODIMENTS

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware embodiments. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-10% from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

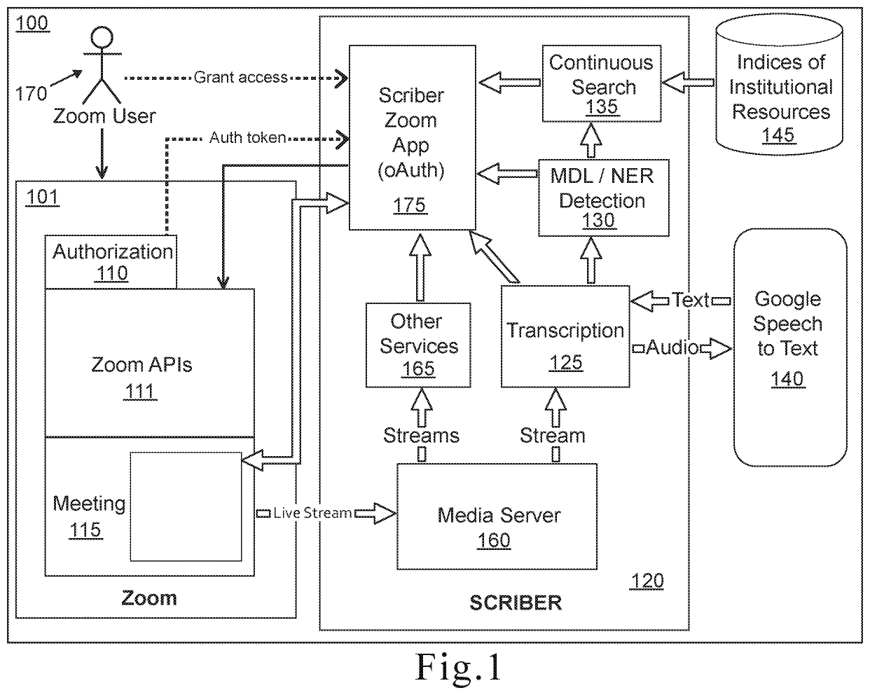

FIG. 1 is a block diagram of one embodiment of a system for organizing, retrieving, and accessing information in real-time.

As shown in FIG. 1, there may be several components to the system 100. The far left, a video conference platform 101 may comprise authentication 110, APIs 111, and user interface components 115. In this architecture, examples of video conference application authentication 110 may be introduced to the system 100. However, this modular component may also extend to various video conferencing software development kits (SDKs) for authentication and integration. That is, the system 100 may utilize a video conferencing platform 101 and receive data therefrom for processing by the other components of the system 100.

The middle portion 120 of the block diagram comprises three modular components: (1) Transcription 125, (2) MDL/NER 130, and (3) Continuous Search 135. The transcription module component 125 may be highly modular and may utilize third-party transcription services 140, preferably those having an application programming interface (API). Alternatively, other transcription modules may be utilized, including one native to the system, or a transcription module developed in the future.

The video conferencing platform 101 may transmit a media stream, which may include audio and/or video, to a media server 160 which may be associated with the middle portion 120. The transcription module component 125 may receive the media from the media server 160. In some embodiments, the media on the media server 160 may be processed by other services 165 for integration into an output application 175 for use by a user 170.

The Minimum Dictionary Language (MDL) and Named Entity Recognition (NER) Detection module components 130 may have substantially similar functionality. MDL/NER 130 may be operable to identify specific keywords or entities (that are predefined as part of a dictionary) that are stated, referenced, or otherwise included in the video conferencing platform. Once the specific keywords or entities are identified, an intelligent transcription event on a document object model (DOM) may automatically logically organize agenda items, action items, notes, or other information identified by the keywords or entities.

The Continuous Search 135 and the notion of ambient intelligence may allow institutional resources 145 that are logically connected to particular named entities as collected during transcription that include inter alia: peer-reviewed sources to support a bullet point, an online profile of an expert, person of interest, or institution, links to intelligent transcripts from previous meetings, other online content, or any other database that the system may have access to. In some embodiments, the system 100 may have access to specific databases or be preprogrammed to prefer certain databases over others.

In one embodiment, continuous search 135 may take utilize information gathered by MDL and/or NER 130 to continuously and actively search for and retrieve information as a transcription is being generated during a conversation. In a preferred embodiment, MDL and/or NER 130 may be utilized by continuous search 135 in order to identify actions to perform (e.g. search or retrieve) and determine upon what input to act on (e.g. search an institutional resource 145, access a previous meeting's action items, or some other action). In a preferred embodiment, the continuous search 135 happens in real time and the system may act as an intelligent assistant to provide help (and sometimes interruptions) as part of the conversation flow.

It is understood that additional modular components may be included for additional functionality.

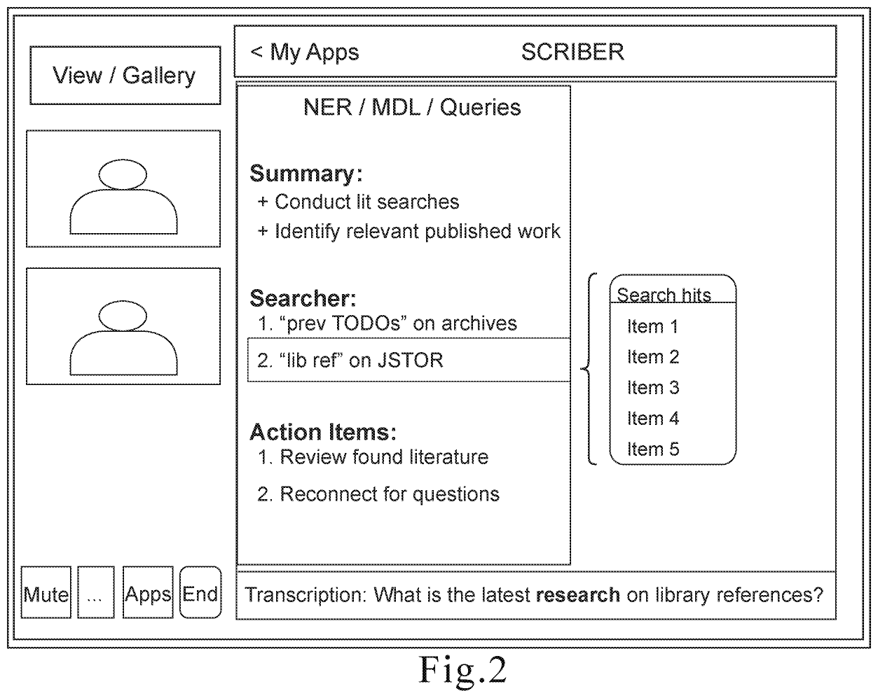

FIG. 2 is an illustration of a graphical user interface of a user reviewing information provided by one embodiment of a system for organizing, retrieving, and accessing information in real-time. The system may be implemented as a video conference application addition or plug-in via an App Marketplace, which may support both: (1) individual users who manage their own installation and authorization, as a user-managed app, and (2) users of institutions where an account admin manages all users' app installation and data authorization, as an account-level app. The system may be web-based and can be fully integrated into a video conference's meeting interface.

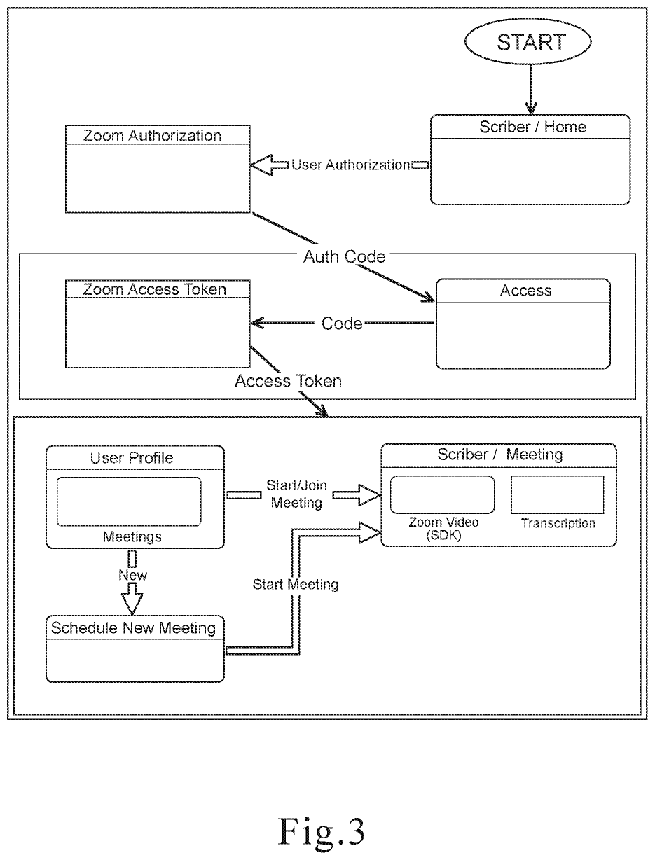

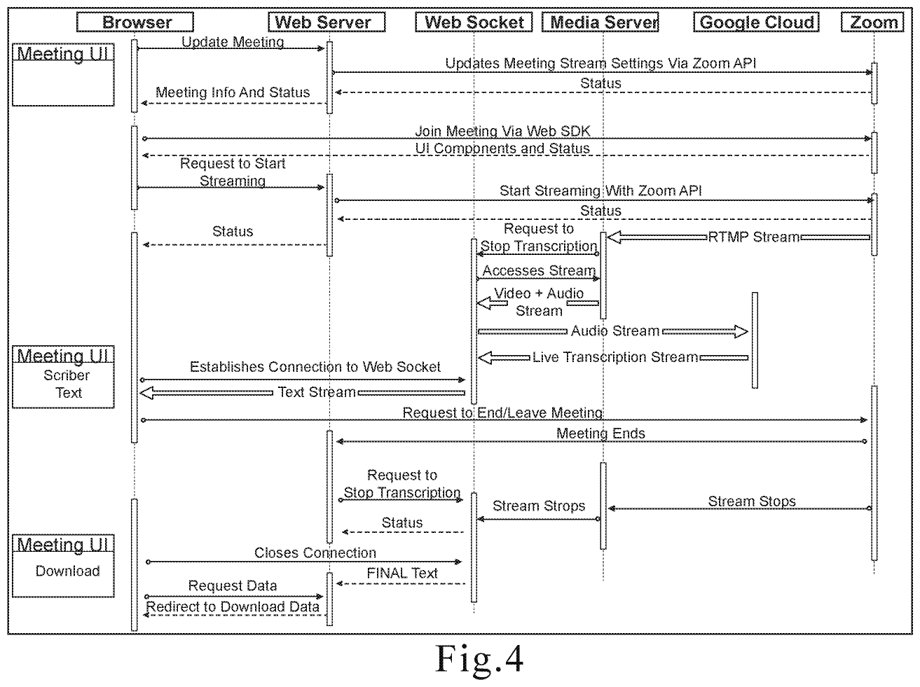

FIGS. 3-4 are flow diagrams showing various security and networking steps for one embodiment of the system for organizing, retrieving, and accessing information in real-time. To install the system onto video conferencing applications, the user (for user-managed apps) or the institutional admin may need to find it on the video conferencing application marketplace, install it, and give authorization (permissions). Once a video conference meeting has started, the user (host) may activate the system, which may start data flow between the video conference application, system, and external sources.

In alternate embodiments, the system may be integrated into a video conferencing application natively.

User authentication may be managed with the system via a video conferencing application's authorization mechanism. One benefit of this is that the meeting stream may be protected and only accessible to those with proper authorization. The live meeting will may be streamed to a server in communication with the system, which may accept incoming data via RTMP and make it available in video formats such as FLV (m3u8 and others in the future) for other internal processes including the system's transcription services.

The transcription module or service may convert the live video stream into an audio stream and transmit the data to a third-party transcription service for transcription, the text of which may then be returned to the transcription module, or other component of the system for further processing. In one embodiment, the text may be transferred to the system itself or an online interface in communication with the system. The text may also be transferred to the MDL and NER modules to identify name entities, concepts, and MDL keywords. Some of the named entities and keywords may be entered into sections of meeting summary, action items, etc. via the dynamic and intelligent document object model parsing. Others named entities and keywords may trigger live continuous searches to query institutional databases and resources. There are interface elements to allow the users (meeting participants) to confirm or dismiss identified entities, e.g. to dismiss an action item. All processed data, including full transcription, notes/entities, searches, and results associated with the searches, will be archived and indexed for future references/inquiries. In some embodiments, the system may display to the users results of the continuous search in real-time. In one embodiment, the system may display the transcription text annotated by the results of the continuous search as the conversation proceeds. This may allow users to retrieve information that might otherwise be “on the tip of their tongue” or other information that may be beneficial in moving a conversation forward.

On the client (front-end) side, video conferencing applications may support OAuth, which may be the mechanism for the system's authentication protocols. On the server side, the system may use JWT (JSON Web Toolkit) for secure integration of related services, including with video conferencing applications. The system may be implemented and deployed as web service APIs in the cloud, which means: 1) they can be hosted on the same servers, different servers (e.g. for load balance), and even as server-less instances (e.g. less overheat/cost); and 2) Beside secure JWT tokens, the system may also verify each other based on IP/domain name/URL patterns as well for extra security.

The system may be used in applications that are not video conferencing applications, including audio conversations, written conversations, or other mechanisms for communication.

In some embodiments, the system may be run on or communicate with a server. The server may be configured to maintain various databases.

In some embodiments, the MDL may comprise a library, such that depending on the language used during a conversation, a specific MDL library may be accessed to provide potentially industry specific specialized feedback, information, and action items. The use of a specific MDL library may also allow for specific triggers.

In one embodiment, the system may be accessible from a user's computer through an online portal. In some embodiments, the system may be a downloadable software program.

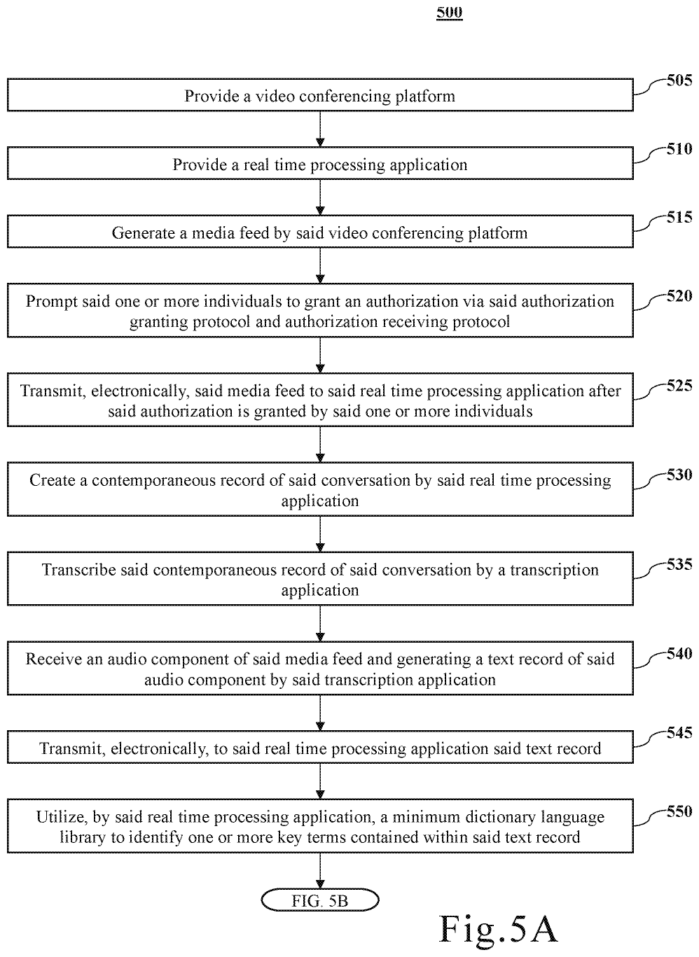

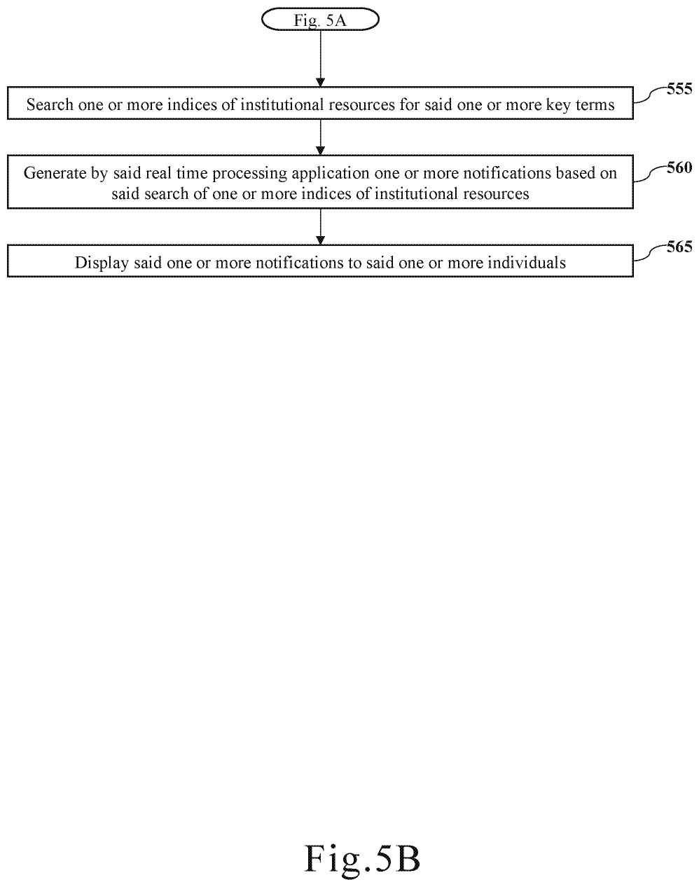

FIGS. 5A-B is a flow diagram showing one method of organizing, retrieving, and accessing data. As shown in FIGS. 5A-B, the method of organizing, retrieving, and accessing data 500 may comprise the steps of providing a video conferencing platform 505 and providing a real time processing application 510. The video conferencing platform may be configured to allow one or more individuals to have a conversation and may comprise an authorization granting protocol. The real time processing application may comprise an authorization receiving protocol.

The method 500 may further comprise the step of generating a media feed by the video conferencing platform 515. In one embodiment, the media feed may comprise audio and/or video.

The method 500 may further comprise the step of prompting the one or more individuals to grant an authorization via the authorization granting protocol and authorization receiving protocol 520.

The method 500 may further comprise the step of transmitting, electronically, the media feed to the real time processing application after the authorization is granted by the one or more individuals 525.

The method 500 may further comprise the step of creating a contemporaneous record of the conversation by the real time processing application 530.

The method 500 may further comprise the step of transcribing the contemporaneous record of the conversation by a transcription application 535. This step may be optional, or in addition to other steps herein.

The method 500 may further comprise the step of receiving an audio component of the media feed and generating a text record of the audio component by the transcription application 540.

The method 500 may further comprise the step of transmitting, electronically, to the real time processing application the text record 545. In one embodiment, the transcription application is a part of the real time processing application.

The method 500 may further comprise the step of utilizing, by the real time processing application, a minimum dictionary language library to identify one or more key terms contained within the text record 550. In one embodiment, the one or more key terms may comprise entities, words, and/or phrases. For example, when one or more individuals are having a conversation, certain words, phrases, or other auditory triggers may appear in such a way that the combination would imply a certain field of though, research, discussion, or other area of information.

The method 500 may further comprise the step of searching one or more indices of institutional resources for the one or more key terms 555.

The method 500 may further comprise the step of generating by the real time processing application one or more notifications based on the search of one or more indices of institutional resources 560. In one embodiment, the generation of the one or more notifications is continuous based on the text record. In this way, as a conversation is proceeding, the individuals may be presented with information and notifications that may assist in furthering the conversation or making the conversation more efficient.

The method 500 may further comprise the step of displaying the one or more notifications to the one or more individuals 565. In one embodiment, the one or more notifications may comprise information. In one embodiment, the one or more notifications may comprise information responsive to the text record. In one embodiment, the one or more notifications are configured to provide information relevant to the text record. In one embodiment, the one or more notifications are configured to allow the one or more individuals to review information to enhance a conversation between the one or more individuals. In some embodiments, the conversation may infer a specific field, and in certain situations, the minimum dictionary language library may be able to identify portions of the specific field explicitly absent from the conversation and this absent information may be included as the notification, or a part thereof. In this way, as a conversation is proceeding, the notifications displayed to the individuals may assist in supplementing or expediting the conversation by providing information to advance the conversation, or to provide information that the individuals appear to be working toward. For example, based on the text as analyzed by the minimum dictionary language library, key words and phrases may be analyzed against outside or third-party repositories of information in order to allow the method 500 to fetch information from the outside or third-party repositories of information that may be useful to the conversation at hand. In some embodiments, the outside or third-party repositories of information may include, in part, past conversations held by one or more individuals and identify how certain types of conversations may proceed, especially as based on conversations including specific key words or terms. In this way, as the outside or third-party repositories of information are used more frequently, they may accumulate more information that when applied by the method 500, may continuously improve the functionality of the method 500.

In some embodiments, the notifications may be displayed to the user in a graphical representation that allows the user to quickly recognize relationships between different keywords based on their usage together. In one embodiment, the stronger a relationship between a particular set of keywords, the larger a bubble containing those keywords may appear. This may allow the user to identify the common relationships at play between the keywords, and potentially be prompted to explore other related keywords.

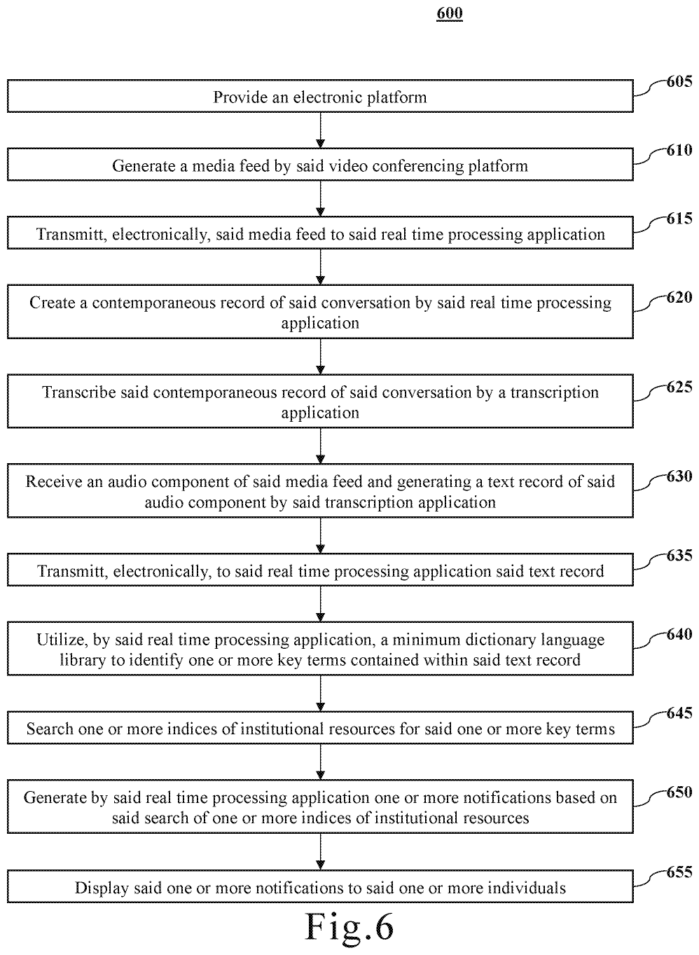

FIG. 6 is a flow diagram showing one method of organizing, retrieving, and accessing data. As shown in FIG. 6, the method of organizing, retrieving, and accessing data 600 may comprise the step of providing an electronic platform 605. In one embodiment, the electronic platform may comprise a video conferencing platform and a real time processing application. In one embodiment, the video conferencing platform is configured to allow one or more individuals to have a conversation.

The method 600 may further comprise the step of generating a media feed by the video conferencing platform 610. In one embodiment, the media feed may comprise audio and/or video.

The method 600 may further comprise the step of transmitting, electronically, the media feed to the real time processing application 615.

The method 600 may further comprise the step of creating a contemporaneous record of the conversation by the real time processing application 620.

The method 600 may further comprise the step of transcribing the contemporaneous record of the conversation by a transcription application 625. This step may be optional or in addition to other steps herein.

The method 600 may further comprise the step of receiving an audio component of the media feed and generating a text record of the audio component by the transcription application 630.

The method 600 may further comprise the step of transmitting, electronically, to the real time processing application the text record 635. In one embodiment, the transcription application is a part of the real time processing application.

The method 600 may further comprise the step of utilizing, by the real time processing application, a minimum dictionary language library to identify one or more key terms contained within the text record 640. In one embodiment, the one or more key terms may comprise entities, words, and/or phrases.

The method 600 may further comprise the step of searching one or more indices of institutional resources for the one or more key terms 645.

The method 600 may further comprise the step of generating by the real time processing application one or more notifications based on the search of one or more indices of institutional resources 650. In one embodiment, the generation of the one or more notifications is continuous based on the text record.

The method 600 may further comprise the step of displaying the one or more notifications to the one or more individuals 655. In one embodiment, the one or more notifications may comprise information. In one embodiment, the one or more notifications may comprise information responsive to the text record. In one embodiment, the one or more notifications are configured to provide information relevant to the text record. In one embodiment, the one or more notifications are configured to allow the one or more individuals to review information to enhance a conversation between the one or more individuals.

In some embodiments, individuals may interact with the system in different ways depending on their roles with respect to projects.

The disclosure presented herein above may be practiced by the use of computers, servers, databases, and other electronic devices.

In view of the exemplary systems described herein, methodologies that may be implemented in accordance with the disclosed subject matter have been described with reference to several flow diagrams. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described herein. Additionally, it should be further appreciated that the methodologies disclosed herein are capable of being stored on an article of manufacture to facilitate transporting and transferring such methodologies to computers.

Those of ordinary skill in the relevant art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

As used in this application, the terms “component,” “module,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/or distributed between two or more computers.

Various embodiments presented in terms of systems may comprise a number of components, modules, and the like. It is to be understood and appreciated that the various systems may include additional components, modules, etc. and/or may not include all of the components, modules, etc. discussed in connection with the figures. A combination of these approaches may also be used.

In addition, the various illustrative logical blocks, modules, and circuits described in connection with certain embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, system-on-a-chip, or state machine. A processor may also be implemented as a combination of computing devices, e.g., a combination of a DSP and a microprocessor, a plurality of microprocessors, one or more microprocessors in conjunction with a DSP core, or any other such configuration.

Operational embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, a DVD disk, or any other form of storage medium known in the art. An exemplary storage medium is coupled to the processor such the processor may read information from, and write information to, the storage medium. In the alternative, the storage medium may be integral to the processor. The processor and the storage medium may reside in an ASIC or may reside as discrete components in another device.

Furthermore, the one or more versions may be implemented as a method, apparatus, or article of manufacture using standard programming and/or engineering techniques to produce software, firmware, hardware, or any combination thereof to control a computer to implement the disclosed embodiments. Non-transitory computer readable media may include but are not limited to magnetic storage devices (e.g., hard disk, floppy disk, magnetic strips), optical disks (e.g., compact disk (CD), digital versatile disk (DVD)), smart cards, and flash memory devices (e.g., card, stick). Those skilled in the art will recognize many modifications may be made to this configuration without departing from the scope of the disclosed embodiments.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those of ordinary skill in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method of organizing, retrieving, and accessing data comprising the steps:
providing a video conferencing platform;
providing a real time processing application;
wherein said video conferencing platform is configured to allow one or more individuals to have a conversation;
wherein said video conferencing platform comprises an authorization granting protocol;
wherein said real time processing application comprises an authorization receiving protocol;
generating a media feed by said video conferencing platform;
prompting said one or more individuals to grant an authorization via said authorization granting protocol and authorization receiving protocol; and
transmitting, electronically, said media feed to said real time processing application after said authorization is granted by said one or more individuals.

2. The method of organizing, retrieving, and accessing data of claim 1, further comprising the step of creating a contemporaneous record of said conversation by said real time processing application.

3. The method of organizing, retrieving, and accessing data of claim 2, further comprising the step of receiving an audio component of said media feed and generating a text record of said audio component by a transcription application.

4. The method of organizing, retrieving, and accessing data of claim 3, further comprising the step of transmitting, electronically, to said real time processing application said text record.

5. The method of organizing, retrieving, and accessing data of claim 4, further comprising the step of utilizing, by said real time processing application, a minimum dictionary language library to identify one or more key terms contained within said text record.

6. The method of organizing, retrieving, and accessing data of claim 5, further comprising the step of searching one or more indices of institutional resources for said one or more key terms.

7. The method of organizing, retrieving, and accessing data of claim 6, further comprising the step of generating by said real time processing application one or more notifications based on said search of one or more indices of institutional resources.

8. The method of organizing, retrieving, and accessing data of claim 7, wherein said one or more key terms comprise entities, words, and/or phrases.

9. The method of organizing, retrieving, and accessing data of claim 7, wherein said generation of said one or more notifications is continuous based on said text record.

10. The method of organizing, retrieving, and accessing data of claim 7, further comprising the step of displaying said one or more notifications to said one or more individuals.

11. The method of organizing, retrieving, and accessing data of claim 10, wherein said one or more notifications comprise information.

12. The method of organizing, retrieving, and accessing data of claim 10, wherein said one or more notifications comprise information responsive to said text record.

13. The method of organizing, retrieving, and accessing data of claim 12, wherein said one or more notifications are configured to provide information relevant to said text record.

14. The method of organizing, retrieving, and accessing data of claim 12, wherein said one or more notifications are configured to allow said one or more individuals to review information to enhance a conversation between said one or more individuals.

15. The method of organizing, retrieving, and accessing data of claim 1, wherein said media feed comprises audio and/or video.

16. The method of organizing, retrieving, and accessing data of claim 10, wherein said transcription application is a part of said real time processing application.

17. A method of organizing, retrieving, and accessing data comprising the steps:
providing an electronic platform;
wherein said electronic platform comprises a video conferencing platform and a real time processing application;
wherein said video conferencing platform is configured to allow one or more individuals to have a conversation;
generating a media feed by said video conferencing platform;
wherein said media feed comprises audio;
transmitting, electronically, said media feed to said real time processing application;
creating a contemporaneous record of said conversation by said real time processing application;
receiving an audio component of said media feed and generating a text record of said audio component by a transcription application;
transmitting, electronically, to said real time processing application said text record;
wherein said transcription application is a part of said real time processing application;
utilizing, by said real time processing application, a minimum dictionary language library to identify one or more key terms contained within said text record;
wherein said one or more key terms comprise entities, words, and/or phrases;
searching one or more indices of institutional resources for said one or more key terms;
generating by said real time processing application one or more notifications based on said search of one or more indices of institutional resources;
wherein said generation of said one or more notifications is continuous based on said text record; and
displaying said one or more notifications to said one or more individuals.
